(19) United States
(12) Patent Application Publication
(10) Pub. No.: US 2014/0170267 A1
(43) Pub. Date: Jun. 19, 2014

(54) BABY AND INFANT FOOD CONTAINING WHOLE OLIVES

(71) Applicants: Mehlika Borcakli, Kocaeli (TR); Tarik Ozturk, Kocaeli (TR); Nabi Uygun, Kocaeli (TR); Ender Gozum, Kocaeli (TR)

(72) Inventors: Mehlika Borcakli, Kocaeli (TR); Tarik Ozturk, Kocaeli (TR); Nabi Uygun, Kocaeli (TR); Ender Gozum, Kocaeli (TR)

(73) Assignee: TUBITAK, Ankara (TR)

(21) Appl. No.: 14/236,913

(22) PCT Filed: Aug. 8, 2012
(86) PCT No.: PCT/IB2012/054045

§ 371 Date: Feb. 4, 2014

(30) Foreign Application Priority Data
Aug. 9, 2011 (TR) 2011/07872

(51) Int. Cl. A23L 1/29

(52) U.S. Cl. CPC A23L 1/296
USPC 426/61; 426/639; 426/71; 426/72; 426/74

(57) ABSTRACT

The subject of this invention is the baby and infant food comprising whole olive fruit. Olive oil have an important role in Mediterranean diet. Olive oil helps to protect the cardiovascular system, to regulate immune system and to protect from cancer. Olive oil with all these properties is used in homemade and also industrially manufactured baby foods. However the only constituent that is useful for health is not the oil. Whole olives, other than oil is more rich in respect to vitamin, mineral, fiber and phenolic substances and contains pure oil not submitted to any extraction process. In spite of all these mentioned advantages of olives, olive oil traditionally is used in baby foods, but olives, mainly due to their bitterness. In the world requirements are increasing besides to their health effect, to less refined and minimally processed foods. For this purpose baby/infant foods having bitter/debittered olives are developed by solving the mentioned problem.

### SUBJECT OF THE INVENTION

Subject of the invention is the baby and infant food containing the whole olives.

### STATE OF THE ART

Olive Oil in Mediterranean Diet

Olive oil has an important role in Mediterranean Diet. Olive oil being the main oil, is used, in preparation of dishes and traditionally in homemade baby foods. Olive oil taking part in Mediterranean diet helps to protect cardiovascular system, regulate immune system and prevent cancer, protect the homeostasis of the body, prevent obesity. (Lopez, 2010; Saura-Calixto and Goñi, 2009; Miranda 2007; Puertollano 2010; Pauwels and Kostkiewicz 2010).

Many consumers, becoming concious by this reason, increase the olive oil consumption and try to be nourished by Mediterranean Diet. This trend inspired some baby food producers such as Plum-Baby and they started to produce baby and infant foods with olive oil. Pureed baby foods constitutes an important part of the baby and infant foods. They are generally sold in sterilized jars and consumed directly, once they are opened.

Difference between Olive Oil and Whole Olives

Olive oil having high content of oil, do not include protein and carbohydrate, but calcium, iron, sodium and potassium in small amount. Besides these, oil soluble alfa, beta and gama tocopherol, vitamin K is found in olive oil. However, in addition to natural oil, whole olives contain 3% lignin, valuable diet fiber with less than 0.5 lignin/cellulose ratio, 80 times more calcium, 8 times more potassium and 6 times more iron than oil, along with magnesium, phosphorus, tin, copper, manganese and selenium. Olives furthermore contains vitamin A, vitamin C, tiamin, niasin, pentothenic acid, vitamin B6, lutein+zeaxhanthin which is not present in olive oil. Whole olive is a good fiber source with 1.5 g fiber content per 100 kcalorie and do not contain compounds such as phytic acid which impedes iron absorbsion. Another important advantage of olives is to have much more oleuropein and other phenolic subtances compared to olive oil. (Peri, E., Raffaelli, A. & Sindona G., 1999 Quantitation of oleuropein in virgin olive oil by ion spray mass spectrometry-selected reaction monitoring, J. Agric. Food Chem., 47, 4156-4160).

In brief, whole olives are much more rich than olive oil in vitamin, mineral, fiber and phenolic substances and contains purest oil not exposed to any extraction process. In the world demand to less processed and refined foods along with health benefits, are increasing. This situation provides an important advantage of competition to baby food containing olives compared to baby food with oil.

In spite of these advantages mentioned above the most important reason that olives are not used in baby foods but traditionally olive oil, is the bitterness of the olive fruit.

Bitterness of olives are traditionally removed in brine or in sodium hydroxide. Olives debittered by salty water is not convenient to baby consumption because of salt content. Debittering of olives with sodium hydroxide is undesirable to babies because of chemical treatment.

For debittering of olives as indicated in the known state of technique in ‘Method and device for removing the bitterness from table olives and product ‘WO2009/106669 A1’ an alternative method is found and without using salt and sodium hydroxide, 1.3-1.8 bar pressurized air at controlled temperature is given to olives in a rotating system during 24-78 hours and oxidation of oleuropein is assured. By this method olives are debittered.

### TECHNICAL PROBLEMS TO BE SOLVED BY THIS INVENTION

Olive fruits have a bitter taste due to mainly its oleuropein and polyphenol content. Bitter taste has to be removed and/or suppressed to be used in baby/infant food. Due to our invention whole olives can be used in baby foods without submitting olives to a special debittering treatment as well. By this way arguments such as olive addition ratio, olive cultivar type, other substances used and bitterness coming from olives can be ignored. Whole olives, used in the products, being subject to this invention, are debittered/bitter olives, not submitted to any chemical treatment but stoneless and reduced to appropriate size. Whole olives in question with all properties and content are mixed at appropriate rates of cereal, fruit, sugar, sweeteneers and all kinds of taste suppression agents to obtain products with suppressed bitter taste.

Bitter taste before being suppressed by mixing at appropriate ratio of cereal, fruit, sugar, sweteneers and all kinds of taste suppression agents, bitterness can be removed by an organic way similar to brining; by using different concentrations of sugar (5%-20%) solutions and fruit/vegetable juice, olive bitterness can be transferred to the sweet water and instead of salty olives, light sugar tasting olives can be obtained.

### EXAMPLE 1

Black olives without stone are placed in water or in black grape juice with sugar content regulated to 5% sugar, in the ratio of 1/1 olive/solution and the container is covered. At the end of 2 days sugar solution is replaced with new one and after waiting in sugar solution, at the end of 3 days, debittered olives with pleasant aroma are obtained.

After removing bitterness with an organic way, remaining bitter taste is suppressed and products with suppressed bitter taste are obtained by mixing whole olives in question with their all properties and content, at appropriate rates of cereal, fruit, sugar, sweeteneers and all kinds of taste suppression agents.

### DESCRIPTION OF THE INVENTION

4.1 Baby Food Production Containing Olives

4.1.1 Pureed Baby Food Production:

In the production of pureed baby food containing olives, cereal is used to increase the viscosity, fruits to give the required taste and olives are added to this basic mixture. Added olives are bitter or debittered and their stones are removed by mechanical processes and reduced to appropriate size that babies and/or infants can eat. Basic mixture is prepared by subjecting the mixture to 50° C.-150° C. during 5 minutes to 1 hour. Olives are added to this mixture at desired ratio between 10%-50%. The mixture obtained at the end of this process is bottled and sterilized between 75° C.-150° C. from 15 seconds to 1 hour, to be ready for consumption.

### EXAMPLE 1

With the aim of bottled baby food preparation 7% rice meal, 14% dried grapes, 16% apple in weight basis and 42% water are put in a cooking vessel with mixer to prepare a baby food base. 21% debittered olive fruit with sugar is added and after homogenization by ultra-tourax, is transferred to glass bottles and sterilized. Another homogenizer can be used to reduce olive fruit into small pieces.

### EXAMPLE 2

13% rice meal, 7% apple, 7% dried grapes, in weight basis and 63% water is heated in a covered cooking vessel until reaching a viscouse structure and bitter, stoneless turning color Edremit olives at ratio of 10% is added. This mixture is homogenized and sterilized in bottles/jars.

Olives other than Edremit cultivar at different maturity stage can be used provided that the bitter substance (oleuropein) is less than 0.3% of the baby food in weigth bases and considering the oil quantity and composition.

The oil quantity should be considered according to the oil quantity and composition of the olive and regulated in the manner that oil quantity will not exceed 5 g in 100 kcal of the baby food. In case it exceeds, linoleic acid level will not be less than 5% (weight basis) of the whole olive fruit oil. Oil extracted olives can be used by taking into account the same oil and linoleic acid ratio.

4.1.2. Powdered Baby Food Production:

Besides pureed baby foods, consumers are interested in powdered formulations that results in baby foods when they are mixed with boiled and warmed water. Whole olives comprising mixture of cereal powder, protein, mineral and vitamin are homogenized after sugar addition in a mixer to prepare this mixture.

### EXAMPLE 3

Hydrolyzed cereal powder having 50% whole olive is mixed with 20% hydrolyzed cereal flour, 16% sugar, 10%-85% milk protein concentrate and 0.02% vitamin, mineral mixture at 54% rate of total baby food weight, in dry basis and all mixture is homogenized in a mixer. In addition, the subject of this invention being the baby/infant foods having whole olive fruits, can contain, additives such as

nucleotids, prebiotics, probiotics, vitamins, minerals and can also be processed by unconventional systems such as UV, pulsed UV, ozon, omic heating and pulsed electric field. This invention is developed for consumption from the 4.months old babies but can be developed for the other age groups with adjuncts addition.

1-14. (canceled)

15. Baby or infant food, which contains salt free and none chemically treated olives that covers processing steps below;
a. Olives are soaked and debittered in 5-20% sugar solution,
b. Olives debittered in sugar solution, where the sugar solution has 5-20% sugar, are pureed,
c. Ingredients except olives are heat treated at 50-150° C. for 5 minutes to 1 hour,
d. Addition of 10-50% (weight basis) olive to the mixture
e. Sterilization of this mixture at 75-150° C. for 15 minutes in jars.

16. Baby or infant food, according to claim 15, wherein oil quantity of olive variety used, is selected according to its composition of olive oil.

17. Baby or infant food, according to claim 15, wherein olives used are debittered in fruit or vegetable juice.

18. Baby or infant food, according to claim 17, wherein bitterness of olives used is removed by soaking in black grape juice.

19. Baby or infant food according to claim 15, wherein the olive varieties having oil with at least 5% linoleic acid are used without the addition of other fat, oil or oil mixture from any source in the baby or infant food.

20. Baby or infant food according to claim 15, wherein 10-50% (weight basis) debittered olives are used giving no more that 7 g/100 kcal in baby or infant food.

21. Baby or infant food according to claim 15, wherein olives are added to baby or infant food at ratio 10-50% (weigth basis), depending on the oleuropein content of olive, being the amount less than 0.3% by weight of the baby food.

22. Baby or infant food according to claim 15, wherein ingredients from the group of nucleotides, prebiotics, probiotics, vitamins, minerals, functional ingredients are added for enrichment.

23. Baby or infant food according to claim 15, wherein debittered olives without treated by salt or other chemicals are used to produce a powdered form of food.

24. Baby or infant food according to claim 23, wherein claims 17-22 applies also to olives used in this powdered formula.
